(19) United States
(12) Patent Application Publication
(10) Pub. No.: US 2023/0328380 A1
(43) Pub. Date: Oct. 12, 2023

(54) Imagery ingestion system and method

(71) Applicants: Gerald Hewes, Lexington, MA (US); Igor Moochnick, Needham, MA (US); Zhikang Ding, Malden, MA (US); Doron Galambos, Newton, MA (US); Julian Gilyadov, Somerville, MA (US); Andrew P. Goldfarb, Brookline, MA (US)

(72) Inventors: Gerald Hewes, Lexington, MA (US); Igor Moochnick, Needham, MA (US); Zhikang Ding, Malden, MA (US); Doron Galambos, Newton, MA (US); Julian Gilyadov, Somerville, MA (US); Andrew P. Goldfarb, Brookline, MA (US)

(21) Appl. No.: 18/016,503

(22) PCT Filed: Jul. 30, 2021
(86) PCT No.: PCT/US2021/043876

§ 371 Date: Jan. 17, 2023

Related U.S. Application Data
(60) Provisional application No. 63/058,618, filed on Jul. 30, 2020.

(51) Int. Cl. H04N 23/67; H04N 23/73; H04N 23/695

(52) U.S. Cl. CPC H04N 23/695; H04N 23/67; H04N 23/73

(57) ABSTRACT

Methods and systems for ingesting imagery. The disclosed methods include receiving at an interface configuration data regarding each of a plurality of imagery gathering devices; configuring, using an imagery coordinating device having a processor executing instructions stored on memory, each of the plurality of imagery gathering devices in accordance with the received configuration data; and instructing each of the plurality of imagery gathering devices to gather imagery in accordance with the received configuration data.

### CROSS-REFERENCE TO RELATED APPLICATIONS

The present application claims the benefit of co-pending United States provisional application no. 63/058,618, filed on Jul. 30, 2020, the entire disclosure of which is incorporated by reference as if set forth in its entirety herein.

### TECHNICAL FIELD

The present application generally relates to systems and methods for gathering imagery and, more particularly but not exclusively, to systems and methods for coordinating one or more imagery gathering devices for ingesting imagery.

### BACKGROUND

In many areas of photography or videography there is a need to expeditiously gather, upload, process, and distribute imagery. Consistency in these imagery-related steps is also important, and inconsistencies can be introduced by mistakes in certain imagery-related situations.

Manufacturers of imagery gathering devices have equipped their devices with Wi-Fi and Ethernet capabilities to assist with the transfer of imagery, such as through components either built-in to their devices or available as add-ons. Some devices even include automatic imagery upload functionality using FTP/SFTP or remote control functionality via HTTP interfaces.

These existing solutions may partially address the need to expeditiously upload imagery. However, the processing of this imagery is typically performed by other, external systems, and this reliance on external systems introduces latency into the delivery of the processed imagery.

Additionally, individual imagery gathering devices are generally under the control of different operators. These photographers may make mistakes or otherwise introduce inconsistencies or quality control issues across gathered imagery.

A need exists, therefore, for systems and methods for ingesting imagery that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to an imagery ingestion system. The system includes an imagery coordinating device in operable communication with a plurality of imagery gathering devices, wherein the imagery coordinating device includes an interface for at least receiving configuration data regarding each of the plurality of imagery gathering devices; a memory; and a processor executing instructions stored on the memory to configure each of the plurality of imagery gathering devices in accordance with the received configuration data, and instruct each of the plurality of imagery gathering devices to gather imagery in accordance with the received configuration data.

In some embodiments, the system further includes a controller in operable communication with the imagery coordinating device, wherein the controller is configured to provide the configuration data to the imagery coordinating device. In some embodiments, the imagery coordinating device configures a first imagery gathering device in accordance with a first configuration instruction, and configures a second imagery gathering device in accordance with a second configuration instruction. In some embodiments, the second configuration instruction is different than the first configuration instruction. In some embodiments, the system further includes an image processor in operable communication with at least one of the plurality of imagery gathering devices, wherein the image processor is configured to receive processing instructions from the controller and process the gathered imagery in accordance with the received processing instructions. In some embodiments, the image processor processes a first image in accordance with a first processing instruction, and processes a second image in accordance with a second processing instruction that is different than the first processing instruction.

In some embodiments, the imagery coordinating device is in operable communication with a structure in operable contact with a first imagery gathering device, and is further configured to provide a movement instruction to the structure to control movement of the first imagery gathering device. In some embodiments, movement of the first imagery gathering device includes a pan movement, a tilt movement, or a rotation movement.

In some embodiments, each of the plurality of imagery gathering devices are positioned at a different location and positioned to gather imagery of at least a first object.

In some embodiments, the imagery coordinating device is configured to adjust a parameter of a first imagery gathering device based on the received configuration data. In some embodiments, the parameter includes lens aperture, shutter speed, image type, or focus.

According to another aspect, embodiments relate to a method of ingesting imagery. The method includes receiving at an interface configuration data regarding each of a plurality of imagery gathering devices; configuring, using an imagery coordinating device having a processor executing instructions stored on memory, each of the plurality of imagery gathering devices in accordance with the received configuration data; and instructing, using the processor, each of the plurality of imagery gathering devices to gather imagery in accordance with the received configuration data.

In some embodiments, the method further includes using a controller in operable communication with the imagery coordinating device to provide the configuration data to the imagery coordinating device. In some embodiments the method further includes, via the imagery coordinating device, configuring a first imagery gathering device in accordance with a first configuration instruction, and configuring a second imagery gathering device in accordance with a second configuration instruction. In some embodiments, the second configuration instruction is different than the first configuration instruction. In some embodiments, the method further includes using an image processor in operable communication with at least one of the plurality of imagery gathering devices to receive processing instructions from the controller, and process the gathered imagery in accordance with the received processing instructions. In some embodiments, processing the gathered imagery in accordance with the received processing instructions includes processing a first image in accordance with a first processing instruction and processing a second image in accordance with a second processing instruction that is different than the first processing instruction.

In some embodiments, the imagery coordinating device is in operable communication with a structure in operable contact with a first imagery gathering device, and the method further includes providing, via the imagery coordinating device, a movement instruction to the structure to control movement of the first imagery gathering device. In some embodiments, movement of the first imagery gathering device includes a pan movement, a tilt movement, or a rotation movement.

In some embodiments, each of the plurality of imagery gathering devices are positioned at a different location and positioned to gather imagery of at least a first object.

In some embodiments, the method further includes, via the imagery coordinating device, adjusting a parameter of a first imagery gathering device based on the received configuration data. In some embodiments, the parameter includes lens aperture, shutter speed, image type, or focus.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates an imagery ingestion system in accordance with one embodiment;

FIG. 2 illustrates the imagery coordinating device of the imagery ingestion system of FIG. 1 in accordance with one embodiment;

FIG. 3 illustrates an imagery ingestion system in accordance with another embodiment;

FIG. 4 illustrates an imagery ingestion system in accordance with yet another embodiment;

FIG. 5 illustrates an imagery ingestion system in accordance with still another embodiment; and

FIG. 6 depicts a flowchart of a method of ingesting imagery in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed previously, there is a need for improved techniques for uploading images and videos (for simplicity, “imagery”) and in ways for processing and distributing this imagery. One existing technique for processing imagery is to use mobile applications (“apps”) executing on a device such as a smartphone. The smartphone is typically connected to a camera using a wireless technology such as Bluetooth or WiFi.

While there are apps available that can upload imagery once gathered, there are many constraints. For example, these apps are often associated with a camera manufacturer’s proprietary technology. Accordingly, interfaces may not be standardized and a user may be required to run multiple apps simultaneously which can be cumbersome and resource intensive. Additionally, Bluetooth-based technology does not have the bandwidth to transfer high resolution imagery.

Other existing techniques may involving connecting a smartphone to a camera using a USB cable. This requires the smartphone to be the USB host, and the camera the USB device. In typical USB configurations, however, the smartphone is the USB device and is connected to a computer host. Driving a smartphone as a USB host is either restricted or not well supported.

The systems and methods described herein allow for the coordination of multiple imagery gathering devices to ingest imagery. The embodiments herein enforce settings on multiple imagery gathering devices to achieve increased consistency and to reduce errors. The disclosed systems may include one or more imagery coordinating devices that are in operable communication with one or more imagery gathering devices to control how and when the imagery gathering devices gather imagery.

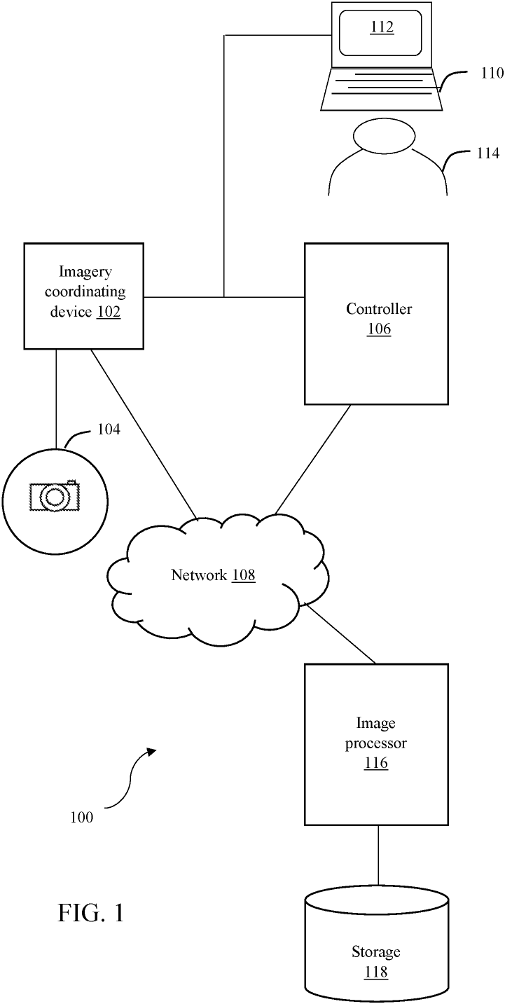

FIG. 1 illustrates a system 100 for ingesting imagery in accordance with one embodiment. In the context of the present application, the term “ingesting” or variations thereof may refer to the process of configuring imagery gathering devices, instructing imagery gathering devices to gather imagery, processing gathered imagery, distributing imagery, or some combination thereof. In the context of the present application, the term “imagery” may refer to still photograph(s), live photograph(s), video(s), infrared images, panoramic shots, or some combination thereof.

The system 100 may include an imagery coordinating device 102 in operable communication with an imagery gathering device 104. The imagery coordinating device (for simplicity, “ICD”) 102 may provide coordination instructions to one or more imagery gathering devices 104. The ICD 102 may receive instructions from a controller 106 or from a user device 110 executing a user interface 112 accessible by a user 114.

The ICD 102 may be accessible by a user 114 from a stand alone device such as the user device 110. The ICD 102 may be implemented as a mobile phone, a computer, a tablet, or any other type of device that allows a user 114 to, for example, view raw imagery, view processed imagery, provide parameters regarding imagery, curate imagery, distribute imagery to others, or the like.

The primary responsibility of the ICD 102 is to interact with the imagery gathering device(s) 104. This interaction may be through either a wired cable such as a USB cable, or through a wireless connection such as Wi-Fi or Bluetooth.

The imagery gathering device 104 may be configured as a camera, video camera, smartphone, tablet, smartwatch, PC, security camera, or any other type of device that can gather imagery, whether available now or invented hereafter. The exact type or configuration of the imagery gathering device(s) 104 used may vary as long as the features of the embodiments described herein may be accomplished.

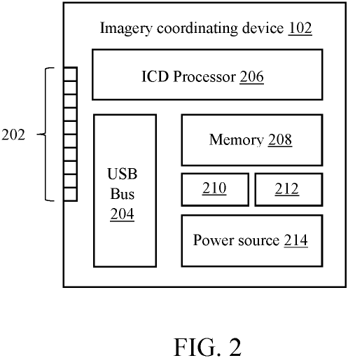

FIG. 2 illustrates the ICD 102 of FIG. 1 in more detail in accordance with one embodiment. The ICD 102 may include a plurality of input/output (I/O) pins 202, a USB bus 204, and an ICD processor 206 executing instructions stored on ICD memory 208. The ICD 102 may further include a Bluetooth circuit 210 to communicate via Bluetooth, a wireless adaptor 212 to connect to a wireless network, and a power source 214.

The processor 206 may be any hardware device capable of executing instructions stored on the memory 208 to configure the imagery gathering device(s) 104. The processor 206 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 206 may be configured as part of the user device 110 (e.g., a laptop) or located at some remote location.

The memory 208 may be L1, L2, L3 cache, or RAM memory configurations. The memory 208 may include non-volatile memory such as flash memory, EPROM, EEPROM, ROM, and PROM, or volatile memory such as static or dynamic RAM, as discussed above. The exact configuration/type of memory 208 may of course vary as long as instructions for ingesting imagery can be performed by the system 100 to accomplish the features described herein.

The power source 214 may include a power board to draw power from and charge any on-board batteries, such as when power is supplied to a USB port. Additionally or alternatively, the power source 214 may include one or more battery components. Any included power board may enable the transfer of power to the ICD 102, and also enable the connection and disconnection of a USB signal between the ICD 102 and the imagery gathering device 104.

Referring back to FIG. 1, the controller 106 may remotely configure the imagery gathering device(s) 104 according to certain preferences or settings through the ICD 102. For example, the controller 106 may adjust the date and time of the imagery gathering device 104, the lens aperture, shutter speed, ISO setting, focus, image type, or the like.

It may be desirable for different imagery gathering devices to be configured differently from each another. For example, an imagery gathering device’s 104 location or orientation may require it to be configured in a certain way based on its ambient lighting. Similarly, it may be necessary to reconfigure the same imagery gathering device throughout the day due to lighting changes.

Different types of imagery may also require different processing procedures or different storage location(s). For example, a user 114 may specify settings to be used for close-up portraits of people and different settings to be used for imagery of groups of people or full body shots.

The controller 106 may provide the configuration instruction(s) to the ICD 102 to configure and coordinate the one or more imagery gathering devices 104. These configuration instructions may also be received from the user device 110. For example, the user interface 112 may allow the user 114 to input parameters such as camera settings, times at which the imagery gathering device(s) 104 should gather imagery, or the like. The controller 106 may communicate these instructions to the ICD 102 over one or more networks 108.

The network(s) 108 may link the various components with various types of network connections. The network(s) 108 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 108 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The system 100 may also include one or more image processors 116 in operable communication with the ICD 102 and the controller 106. The image processor(s) 116 may process imagery according to specified instructions or imagery processing procedures. These instructions may include applying filters, lighting adjustments, cropping, as well as applying various computer vision procedures to analyze the content of the gathered imagery.

Once the procedure(s) are completed, the original and processed imagery may be stored in storage 118. The storage 118 may refer to any one or more of S3, Google Drive®, Google Photo®, Dropbox®, local filesystems, or the like. Imagery may then be accessed and distributed to one or more users or interested parties.

In some embodiments, the system 100 may execute logical operations to automatically store imagery of different categories in different locations. For example, the image processor 116 can select imagery for further review according to some specified criteria. For example, imagery can be discarded if it is too dark (e.g., the flash did not execute), if there are no people in the imagery, etc.

In some embodiments, the controller 106 and the image processor 116 may run on the same computer system. In other embodiments, the controller 106 and the image processor 116 may run on different computer systems.

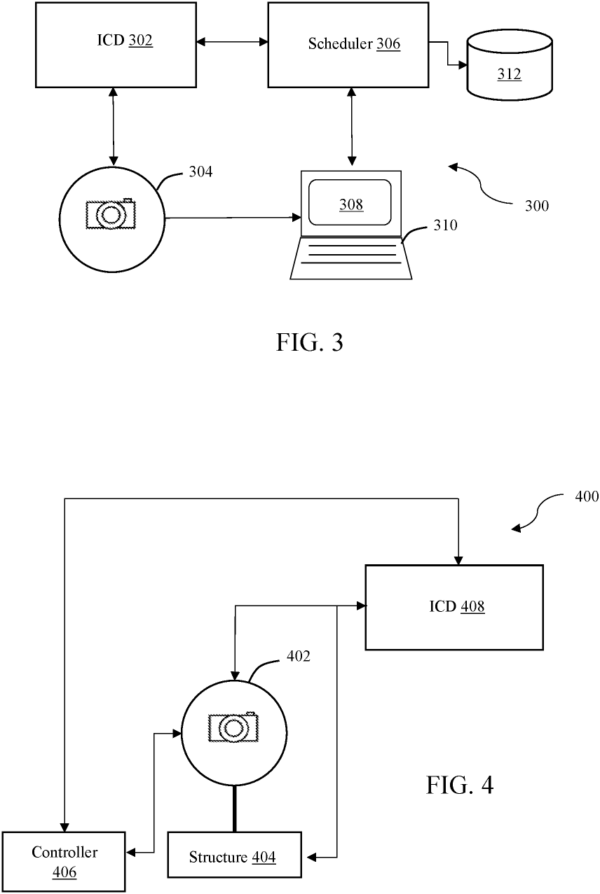

FIG. 3 illustrates an imagery ingestion system 300 in accordance with another embodiment. The system 300 may include an ICD 302 such as the ICD 102 of FIG. 1 in communication with an imagery gathering device 304. The imagery gathering device 304 may be similar to the imagery gathering device 104 of FIG. 1.

As seen in FIG. 3, the ICD 302 may be in further communication with a scheduler 306 that may present imagery on a user interface 308 executing on a user device 310. The presented imagery may have been previously stored in storage 312 or otherwise previously gathered. Specifically, the scheduler 306 may scan the storage 312 for new imagery to display via the user interface 112. As in previous embodiments, the ICD 302 may control how and when the imagery gathering device 304 gathers imagery.

FIG. 4 illustrates an imagery ingestion system 400 in accordance with another embodiment. In this embodiment, an imagery gathering device 402 may be a camera operably connected to or otherwise in communication with a structure 404 controlled remotely by a controller 406 or by another device that operates either automatically or through the supervision of a person (not shown in FIG. 4). In one embodiment, an ICD 408 such as the ICD 102 of FIG. 1 can configure the imagery gathering device 402.

The structure 404 may be a platform or other type of structure configured with, for example, gears, actuators, slider mechanisms, or the like to control movement of the imagery gathering device 402 based on movement instructions from the controller 406. For example, the controller 406 may instruct the structure 404 to perform a rotation movement, pan movement, tilt movement, slide movement, or some combination thereof to control movement of the imagery gathering device 402.

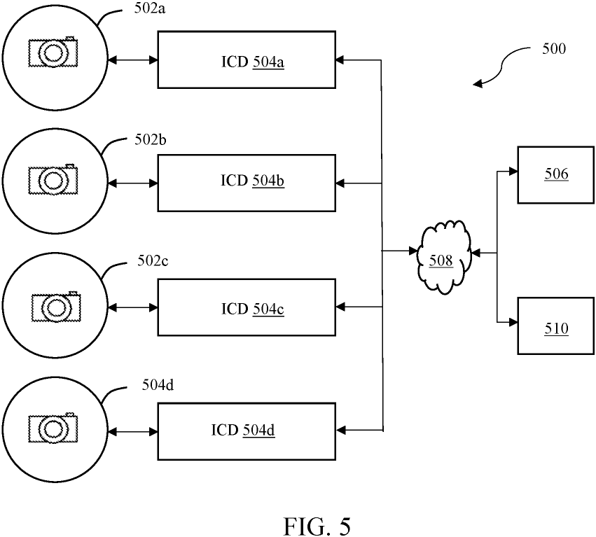

FIG. 5 illustrates an imagery ingestion system 500 in accordance with another embodiment. In this embodiment, the system 500 includes a plurality of imagery gathering devices 502a-d that are each associated with an ICD 504a-d (e.g., ICD 504a is associated with imagery gathering device 502a, etc.).

In this embodiment, a single controller 506 may be in operable communication with and responsible for managing each of the ICDs 504a-d. The controller 506 may be in communication with the ICDs 504a-d over one or more networks 508. The controller 506 may also be in communication with one or more image processors 510 such as the image processor 116 of FIG. 1.

The systems of FIGS. 1 and 3-5 and components thereof are not mutually exclusive. For example, some embodiments may include components of multiple systems, such as the scheduler 306 of FIG. 3 and the structure 404 of FIG. 4.

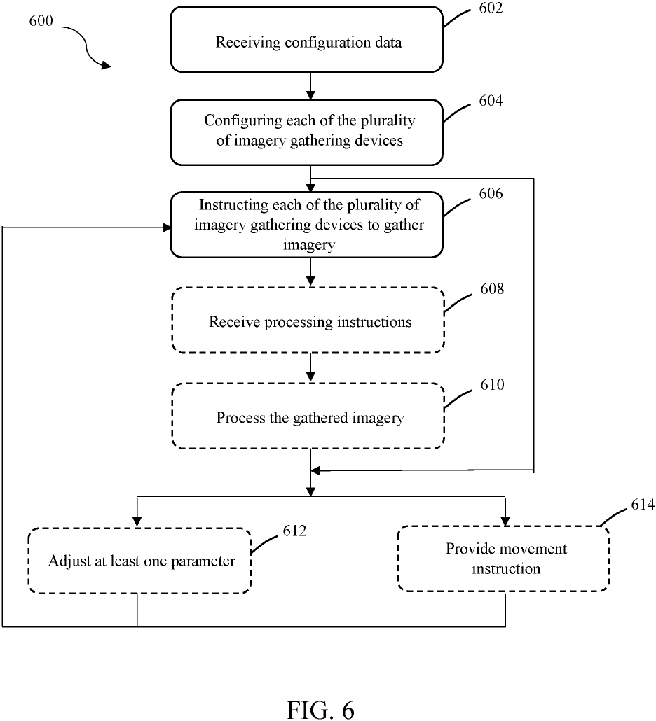

FIG. 6 depicts a flowchart of a method 600 of ingesting imagery in accordance with one embodiment. The systems of any one of FIGS. 1 and 3-5 or components thereof may perform the steps of method 600.

Step 602 involves receiving at an interface configuration data regarding each of a plurality of imagery gathering devices. These configuration instructions may relate to how an imagery coordinating device should configure one or more imagery gathering devices, and may be provided by a controller such as the controller 106 of FIG. 1.

Step 604 involves configuring, using an imagery coordinating device having a processor executing instructions stored on memory, each of the plurality of imagery gathering devices in accordance with the received configuration data. Step 604 may involve configuring multiple imagery gathering devices. For example, the imagery coordinating device may configure a first imagery gathering device in accordance with a first configuration instruction and may configure a second imagery gathering device in accordance with a second configuration instruction. In some embodiments, the first and second configuration instructions may be the same such that the first and second imagery gathering devices are configured in the same way. In other embodiments, the first and second configuration instructions may be different such that the first and second imagery gathering devices are configured differently.

Step 606 involves instructing, using the processor, each of the plurality of imagery gathering devices to gather imagery in accordance with the received configuration data. The imagery gathering devices may then gather imagery in their respective locations. For example, a first imagery gathering device may be positioned at a first location and directed towards a first object. In accordance with the received instruction(s), the first imagery gathering device may take a photograph, a live photograph, a video, or some combination thereof of the first object. The instructions may involve the imagery gathering device taking photographs at certain frequencies such as every five minutes, for example.

A second imagery gathering device may be positioned at a second location and directed towards the first object or a second object that is different than the first object. The second imagery device may be instructed to gather imagery at different frequencies than the first imagery gathering device, and may also be instructed to gather different types of imagery than the first imagery gathering device. Alternatively, the first and second imagery gathering devices may be instructed to gather the same types of imagery at the same time(s).

Step 608 is optional and involves receiving processing instructions from the controller. These instructions may be provided to an image processor such as the image processor 116 of FIG. 1, and may include instructions regarding how to process the gathered imagery. Step 610 is optional and involves and processing the gathered imagery in accordance with the received processing instructions. For example, the image processor may apply any appropriate filters, lighting adjustments, or the like.

Step 612 is optional and involves adjusting, via the imagery coordinating device, a parameter of a first imagery gathering device based on the received configuration data. For example, the parameter adjusted may include the lens aperture, shutter speed, image type, focus, or some combination thereof.

Step 614 is optional and involves providing, via the imagery coordinating device, a movement instruction to a structure to control movement of the first imagery gathering device. In some embodiments, the imagery gathering device may be positioned on or otherwise in operable contact with a structure such as a platform. The structure may include one or more controls that, when instructed by the imagery coordinating device, cause the imagery gathering device to move in a certain way.

The steps of method 600 may be performed in different orders than that illustrated in FIG. 6, and some steps may performed in a single iteration of the method 600. For example, steps 612 and 614 may both be performed before step 606 is performed and imagery is gathered.

Multiple iterations of method 600 may be performed as well. For example, imagery may be processed in step 610. Then, the controller may provide a movement instruction in step 614 or instruct the imagery coordinating device to adjust a parameter in step 612 (e.g., to change the orientation of an imagery gathering device or a setting thereof) to improve the imagery gathered in future iterations. The method 600 may then proceed back to step 606 to gather additional imagery. Accordingly, method 600 may be an iterative process in which imagery is gathered and feedback on the gathered imagery (whether provided by a user or through computer vision procedures) is used to continuously reconfigure the imagery gathering devices to gather additional imagery.

The systems and methods described herein may be implemented in a variety of applications. For example, the embodiments herein may be implemented by individuals or team photographers to optimize how imagery is gathered.

In some embodiments, the imagery gathering device(s) may be stationary and in fixed locations. For example, in sporting venues, imagery gathering devices may be positioned and configured to gather imagery of billboards, scoreboard displays, projection screens, structures, or the like. The ICDs described herein may also be used in automated booth setups, in which an imagery gathering device may be positioned in a certain location and configured to gather imagery of people at that location. Other exemplary applications include those associated with municipal infrastructure, traffic monitoring, security systems, military or defense applications, satellite imagery acquisition systems, or the like.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. An imagery ingestion system comprising:
an imagery coordinating device in operable communication with a plurality of imagery gathering devices, wherein the imagery coordinating device includes:
an interface for at least receiving configuration data regarding each of the plurality of imagery gathering devices,
a memory, and
a processor executing instructions stored on the memory to:
configure each of the plurality of imagery gathering devices in accordance with the received configuration data, and
instruct each of the plurality of imagery gathering devices to gather imagery in accordance with the received configuration data.

2. The system of claim 1 further comprising a controller in operable communication with the imagery coordinating device, wherein the controller is configured to provide the configuration data to the imagery coordinating device.

3. The system of claim 2, wherein the imagery coordinating device:
configures a first imagery gathering device in accordance with a first configuration instruction, and
configures a second imagery gathering device in accordance with a second configuration instruction.

4. The system of claim 3 wherein the second configuration instruction is different than the first configuration instruction.

5. The system of claim 2 further comprising an image processor in operable communication with at least one of the plurality of imagery gathering devices, wherein the image processor is configured to:
receive processing instructions from the controller, and
process the gathered imagery in accordance with the received processing instructions.

6. The system of claim 5, wherein the image processor:
processes a first image in accordance with a first processing instruction, and
processes a second image in accordance with a second processing instruction that is different than the first processing instruction.

7. The system of claim 1 wherein the imagery coordinating device is in operable communication with a structure in operable contact with a first imagery gathering device, and is further configured to provide a movement instruction to the structure to control movement of the first imagery gathering device.

8. The system of claim 7 wherein movement of the first imagery gathering device includes a pan movement, a tilt movement, or a rotation movement.

9. The system of claim 1 wherein each of the plurality of imagery gathering devices are positioned at a different location and positioned to gather imagery of at least a first object.

10. The system of claim 1 wherein the imagery coordinating device is configured to adjust a parameter of a first imagery gathering device based on the received configuration data.

11. The system of claim 10 wherein the parameter includes lens aperture, shutter speed, image type, or focus.

12. A method of ingesting imagery, the method comprising:
receiving at an interface configuration data regarding each of a plurality of imagery gathering devices;
configuring, using an imagery coordinating device having a processor executing instructions stored on memory, each of the plurality of imagery gathering devices in accordance with the received configuration data; and
instructing, using the processor, each of the plurality of imagery gathering devices to gather imagery in accordance with the received configuration data.

13. The method of claim 12, further comprising, using a controller in operable communication with the imagery coordinating device to provide the configuration data to the imagery coordinating device.

14. The method of claim 13 further comprising, via the imagery coordinating device:
configuring a first imagery gathering device in accordance with a first configuration instruction, and
configuring a second imagery gathering device in accordance with a second configuration instruction.

15. The method of claim 14 wherein the second configuration instruction is different than the first configuration instruction.

16. The method of claim 13 further comprising, using an image processor in operable communication with at least one of the plurality of imagery gathering devices to:
receive processing instructions from the controller, and
process the gathered imagery in accordance with the received processing instructions.

17. The method of claim 16 wherein processing the gathered imagery in accordance with the received processing instructions includes:
processing a first image in accordance with a first processing instruction, and
processing a second image in accordance with a second processing instruction that is different than the first processing instruction.

18. The method of claim 12 wherein the imagery coordinating device is in operable communication with a structure in operable contact with a first imagery gathering device, and the method further includes providing, via the imagery coordinating device, a movement instruction to the structure to control movement of the first imagery gathering device.

19. The method of claim 18 wherein movement of the first imagery gathering device includes a pan movement, a tilt movement, or a rotation movement.

20. The method of claim 12 wherein each of the plurality of imagery gathering devices are positioned at a different location and positioned to gather imagery of at least a first object.

21. The method of claim 12 further comprising, via the imagery coordinating device, adjusting a parameter of a first imagery gathering device based on the received configuration data.

22. The method of claim 21 wherein the parameter includes lens aperture, shutter speed, image type, or focus.
